(19) United States
(12) Patent Application Publication
(10) Pub. No.: US 2023/0113348 A1
(43) Pub. Date: Apr. 13, 2023

(54) METHOD AND SYSTEM WITH HIGH SPEED MOTOR AND SPEED LIMITED PUMP

(71) Applicant: GM GLOBAL TECHNOLOGY OPERATIONS LLC, Detroit, MI (US)

(72) Inventor: Robert Benson Parrish, White Lake, MI (US)

(73) Assignee: GM GLOBAL TECHNOLOGY OPERATIONS LLC, Detroit, MI (US)

(21) Appl. No.: 17/450,563

(22) Filed: Oct. 12, 2021

(51) Int. Cl. F04C 29/00; F04C 2/10

(52) U.S. Cl. CPC F04C 29/005; F04C 2/10; F16H 2057/0087

(57) ABSTRACT

Systems and methods are provided for pump systems that deliver optimized performance and efficiency. A method includes selecting a pump for the pump system. A maximum operating speed of the pump is determined, and its torque requirements are evaluated. A motor is selected to meet the torque requirements and a speed target is set for the motor. A speed reducer is sized for operation of the motor at the speed target and operation of the pump below the maximum speed, and the motor is coupled with the pump through the speed reducer.

### INTRODUCTION

The present disclosure generally relates to electric motor driven pump systems and more specifically, to pump systems providing desired and optimized performance characteristics by leveraging high speed motor input while limiting the rotational speed of the pump.

Pump systems of apparatus such as vehicles and other equipment and machinery, move fluids and/or generate pressures for a variety of purposes. Many types of pumps are available and each generally requires a motive input device (motor), such as one that operates on electric, pneumatic, hydraulic, or mechanical power to drive moving parts of the pump. The type of pump selected is driven by the operational requirements of the pump system and the load services by the pump. The design and operating conditions of the pump determine the amounts of torque or force required to drive the moving parts. The amount of torque/force required influences the cost, weight and type of the motive input device that is appropriate for use. For example, when an electric motor is used to drive the pump, the types and the design of the electric motor is dictated by the input requirements and performance capabilities of the selected pump.

In a given fluid system, the pump that is selected and the work done by the fluid influences the selection of a paired motor that will achieve the performance requirements for a given application. In applications such as those for vehicles, size and its impact on weight may have an influence on factors such as fuel economy. The amount of electric power consumed is also preferably minimized. In addition, motor cost is an ongoing concern. As a result, in designing pump systems, the type of motor used and operational capabilities of the motor are considered.

Accordingly, it is desirable to provide a pump system for a given application that results in appropriate performance characteristics such as torque/force requirements and provides a desired level of efficiency at minimized cost. Furthermore, other desirable features and characteristics of the present invention will become apparent from the subsequent detailed description and the appended claims, taken in conjunction with the accompanying drawings and the foregoing technical field and background.

### SUMMARY

Systems and methods are provided for pump systems that deliver desirable performance characteristics such as operating the motor at a relatively high speed while operating the pump at a lower, limited speed. In a number of embodiments, a method includes selecting a pump for the pump system. A maximum operating speed of the pump is determined, and its torque requirements are evaluated. A motor is selected to meet the torque requirements and a speed target is set for the motor. A speed reducer is sized for operation of the motor at the speed target and operation of the pump below the maximum speed, and the motor is coupled with the pump through the speed reducer.

In additional embodiments, determining the maximum speed includes determining a high speed fill limit of the pump above which fluid flow of the pump is independent of speed change, and the maximum speed is set at a threshold below the high speed fill limit.

In additional embodiments, sizing the speed reducer includes selecting a gear ratio of the speed reducer that results in operating the pump below the high speed fill limit when the motor is operated at the speed target.

In additional embodiments, evaluating the torque requirements includes evaluating the torque requirements for the pump through a range of operating temperatures and flow rates of the pump system.

In additional embodiments, setting the speed target includes evaluating, simultaneously, speed and torque requirements of the motor.

In additional embodiments, selecting the speed reducer includes selecting the speed reducer that reduces speed from the motor to the pump and that increases torque transferred from the motor to the pump.

In additional embodiments, selecting the motor includes selecting a brushless direct-current motor. Selecting the speed reducer includes selecting a planetary gearset for the speed reducer. The motor is coupled to the planetary gearset, and the pump is coupled to the planetary gearset.

In additional embodiments, the pump is fluid coupled with a load, and the pump is sized to meet flow requirements of the load.

In additional embodiments, sizing the pump includes evaluating flow requirements of the load over a range of operating temperatures.

In additional embodiments, a maximum torque required to drive the pump is determined over an operating temperature range of the pump.

In a number of other embodiments, a pump system includes a pump configured to operate at a maximum speed and with torque requirements. A motor is configured to meet the torque requirements and to operate at a speed target. A speed reducer is coupled with the motor and the pump, and is configured to operate the pump below the maximum speed when the motor is operated at the speed target.

In additional embodiments, the pump is configured to operate at the maximum speed, which is lower than a high speed fill limit of the pump above which fluid flow of the pump is independent of speed change.

In additional embodiments, the speed reducer includes gearing with a ratio that results in operating the pump below the high speed fill limit when the motor is operated at the speed target.

In additional embodiments, the motor and the speed reducer are configured to deliver torque requirements for the pump through a range of operating temperatures and flow rates of the pump system.

In additional embodiments, the motor is configured to operate at the speed target and simultaneously to meet the torque requirements of the pump over a range of operating temperatures.

In additional embodiments, the speed reducer reduces speed from the motor to the pump and increases torque transferred from the motor to the pump.

In additional embodiments, the motor is a brushless direct-current motor, and the speed reducer includes a planetary gearset. The motor is coupled to the planetary gearset, and the pump is coupled to the planetary gearset.

In additional embodiments, a load serviced by the pump, the pump is fluid coupled with the load, and the pump is configured to meet flow requirements of the load.

In additional embodiments, the pump is configured to deliver flow requirements of the load over a range of operating temperatures.

In a number of additional embodiments, a method of manufacturing a pump system includes selecting a pump for the pump system. The pump is fluid coupled in a fluid system with a load that is operated using fluid supplied by the pump. A high speed fill limit of the pump above which fluid flow of the pump is independent of speed change of the pump is determined. A maximum operating speed of the pump is set at a threshold below the high speed fill limit. Torque requirements of the pump are evaluated through a range of operating temperatures and flow rates of the fluid system. A motor is selected to meet the torque requirements. A speed target is set for the motor above ten-thousand revolutions per minute. A speed reducer is selected and sized for operation of the motor at the speed target and operation of the pump below the maximum speed. The motor is coupled with the pump through the speed reducer. The pump is coupled with the load to supply the load with fluid from the pump.

### BRIEF DESCRIPTION OF THE DRAWINGS

The exemplary embodiments will hereinafter be described in conjunction with the following drawing figures, wherein like numerals denote like elements, and wherein:

FIG. 1 is a schematic illustration of a pump system, in accordance with various embodiments;

FIG. 2 is a graph of flow versus rotational speed for the pump of the pump system of FIG. 1, in accordance with various embodiments;

FIG. 3 is a graph of torque versus rotational speed for the motor of the pump system of FIG. 1, in accordance with various embodiments; and

FIG. 4 illustrates a method of manufacturing the pump system of FIG. 1, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding introduction, brief summary or the following detailed description.

For the systems and methods disclosed herein, mated pump and motor performance requirements and characteristics are jointly considered and balanced for benefits such as to maximize efficiency and reduce cost. The pump moves a fluid to flow by increasing pressure so that the pressurized fluid moves to a lower pressure region of the system and to power operation of a load such as a drive unit. The characteristics of the pump are determined by considering the requirements of the load that will use the pumped fluid, and of the system through which the fluid is pumped. Therefore, a pump is selected with flow and pressure ratings selected and sized to match the flowrate and pressure required for the application's load and system. The rotational speed at which the pump will be operated is considered, and the system is configured so the pump's operating speed is maintained below a maximum desirable threshold.

The currently disclosed embodiments may employ a high speed electric motor coupled with the pump in an optimized system that may include a specifically tailored speed reduction in the coupling between the motor and the pump. The motor performs with higher efficiency when spinning at higher speeds with relatively low torques. System torque requirements are evaluated to ensure the maximum required torque is provided when needed in driving the pump, while motor speed is maintained for efficiency. In certain embodiments, such as vehicle applications, the high speed motor is supplied with electric power by a forty-eight volt power source for efficiently driving the motor at high speed, and the pump operates at robust functional speed for durability, noise minimization, and to avoid outcomes such as cavitation.

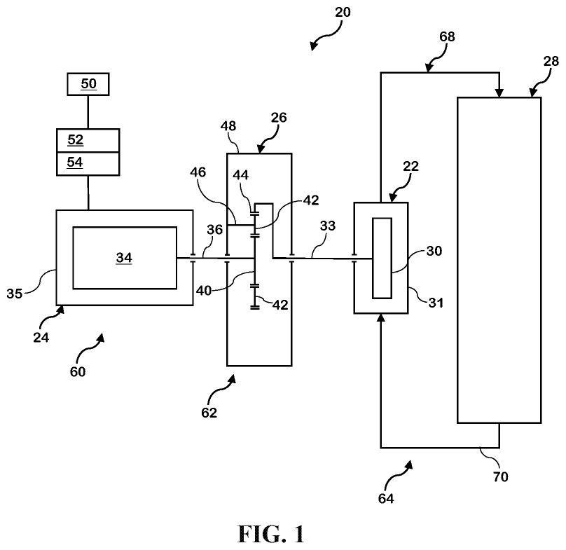

Referring to FIG. 1, an exemplary pump system 20 generally includes a pump 22 as a fluid driver, a motor 24 as a motive input device, a speed reducer 26, coupled between the motor 24 and the pump 22 to transfer torque in driving the pump 22. A load 28 uses the pumped fluid and is serviced by the pump 22. In the embodiments disclosed herein, certain motor types, pump types, and torque transfer arrangements may be described. In other embodiments of the current disclosure as described in the claims, other motive drivers (motors 24), other fluid power sources (pumps 22), and other torque transfer arrangement devices (speed reducers 26), are contemplated. For example, the pump 22 may be a rotary, reciprocating or other type of pump. The pump 22 may be a positive displacement pump, such as an internal or external gear pump, or may be another type such as a centrifugal pump with an impeller. In an embodiment, the pump 22 is an internal gear-type pump, such as a gerotor pump. The pump 22 includes a rotor 30 in a housing 31, with a pump shaft 33 connected with the rotor 30. In other embodiments, any pump that may experience undesirable fill related outcomes may benefit from the details of this disclosure.

The motor 24 may be any of various types of electric motors. In some embodiments such as for automotive applications, a brushless direct current (BLDC) motor 24 may be employed. Employing a BLDC motor 24 provides a relatively small and compact package that may be desirable for applications where space and weight are considered, such as automotive applications. A BLDC motor may be particularly desirable for electric vehicle applications where battery power is limited, and relatively high voltage is available. Therefore, the use of BLDC motors 24 in automotive and other applications may be desirable in driving various types of pumps 22 to provide motive fluid power for various types of loads 28. In general, the current disclosure may be applicable in any application where high speed operation of the electric motor 24 is desirable, without overdriving the pump 22. The motor 24 generally includes a stator 34 and a rotor 35, with a shaft 36 connected with the rotor 35.

The load 28 may be any unit that uses a flow of fluid to do work. In an embodiment, the load 28 is the fluid system for operating a drive unit of a vehicle. For example, a hydraulic drive unit may employ fluid power for actuation to effect control, shifting and/or to transfer torque. In other embodiments, the load 28 may be an actuator that provides power/motion for any use.

The speed reducer 26 may be any of various types of torque transferring and input-output ratio defining mechanisms. For example, the speed reducer 26 may be a geartrain arrangement, a sprocket and chain arrangement, a pulley and belt arrangement, a combination therefor, or another type of mechanism that transfers torque and defines the input-output speed ratio. In the current embodiment, the speed reducer 26 includes a planetary gear arrangement with a sun gear 40, planet gears 42, a ring gear 44, and a planet carrier 46. To provide a speed reduction, the input from the motor shaft 36 is delivered to the sun gear 40, output to the pump shaft 33 is provided from the ring gear 44, and the planet carrier 46 is fixed, such as to a case 48. The various gears are sized to provide the input-output ratio desired.

Also shown in FIG. 1, the motor 24 is served by a power supply 50, which in this embodiment may be a forty-eight volt automotive electrical power supply including a battery source. The use of a relatively high automotive voltage such as forty-eight volts supports the option of operating the motor 24 at higher speeds than a lower voltage might efficiently provide. A controller 52 is coupled with the motor 24 to provide control functions and a driver and power electronics module 54 is included for operation of the motor 24. The controller 52 and the power electronics module 54 are configured to operate the motor 24 at desirable speeds and to supply the requirements of the load 28.

The pump system 20 includes an electrical system 60, a mechanical system 62 and a fluid system 64. The electrical system 60 includes the motor 24, the power supply 50, the controller 52 and the driver and power electronics module 54. Other elements such as various sensors, actuators and other conventional elements are not shown. The mechanical system 62 includes the motor shaft 36, the speed reducer 26 and the pump shaft 33. Other elements, such as the rotor 30, 35 may be considered a part of the mechanical system for various purposes. The fluid system 64 includes the pump 22, the load 28 and the fluid circuit 68. The fluid circuit 68 includes the fluid passageways in the pump 22 and in the load 28 and includes the conduits 70 interconnecting the various elements. Other elements such as heat exchangers, valves and reservoirs are not shown.

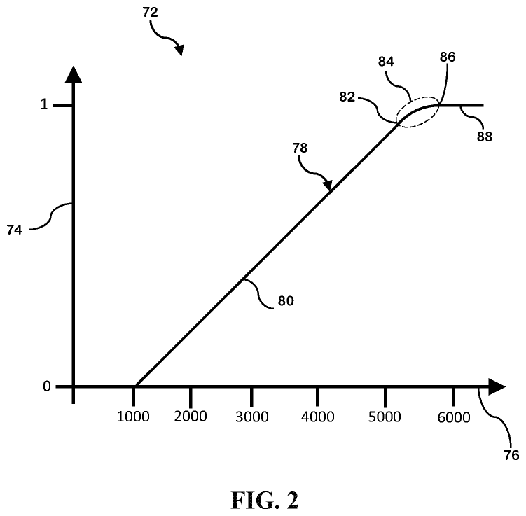

Referring to FIG. 2, a graph 72 illustrates, for the pump 22, normalized flow (no flow of zero to a maximum flow of one) on the vertical axis 74, versus shaft speed on the horizontal axis 76 in revolutions per minute. The curve 78 for the pump 22 demonstrates, specifically in the segment 80 of the curve 78, that as shaft speed increases flow delivery increases. For the pump 22, flow rate is directly proportional to speed in the segment 80 up until the inflection point 82 of the curve 78. Speeds higher than the inflection point 82 result in rapidly diminishing returns in flow for speed increases through the segment 84 of the curve 78 (indicated inside the ellipse). Following the inflection point 86 of the curve 78, further speed increases result in no increases in flow rate in the segment 88 where the pump flow-rate levels off to become independent of further increases in the rotational speed. Accordingly, operating at speeds higher than point 86 are not beneficial from an efficiency perspective. In addition, operation of the pump 22 in or above the segment 84 has been found to lead to undesirable outcomes such as noise and wear. For example, mixing of air in the fluid (cavitation) may occur when speed rates lead to the inability of the pumped fluid from fully filling the pump 22. Accordingly, in the segment 84 of the curve 78, the pump 22 has reached its high speed fill limit. In the current embodiment, the high speed fill limit is in the range of approximately 5000-6000 revolutions per minute, depending on characteristics of the motor 24 and the fluid system 64. Therefore, operation of the pump 22 at or above the high speed fill limit is not desirable from a product operation, quality and/or durability perspective.

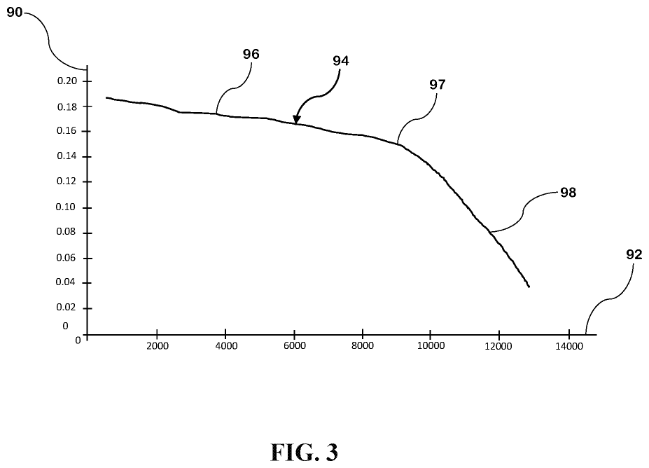

Referring to FIG. 3, a graph depicts torque in newton-meters on the vertical axis 90 versus speed in revolutions per minute on the horizontal axis 92 for the motor 24. Curve 94 represents a torque-speed characteristic curve of the motor 24. The curve 94 demonstrates that beginning from a maximum torque point at or near the vertical axis 90 at relatively slow speed, torque decreases relatively slowly as speed increases in the segment 96 of the curve 94. Following an inflection point 97 of the curve 94, torque decreases relatively quickly as speed increases in the segment 98 of the curve 94. For the motor 24, operation efficiency is maximized in the segment 98, which is at shaft speeds of approximately 10,000-14,000 revolutions per minute, where torque may be less than fifty-percent of the maximum torque point for the motor 24. Efficient speeds for a given motor may be determined from performance data available from the pump manufacturer, or may be determined from performance testing and/or modelling.

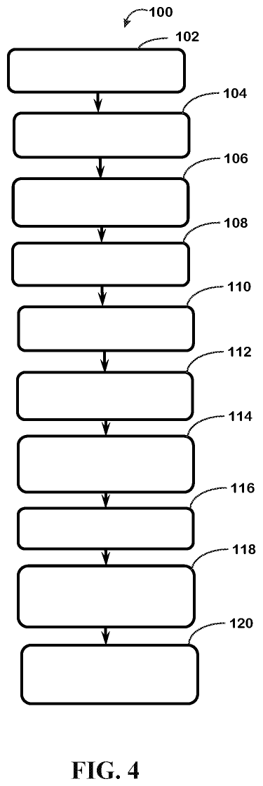

A process 100 for developing and manufacturing the pump system 20 is illustrated in FIG. 4 in flow chart form. The process 100 begins with the design 102 of the fluid circuit 68 to service the load 28. The characteristics of the fluid circuit 68 are determined to meet the requirements of the load 28 and to fit the packaging and physical layout requirements of the application. Given the load 28 and the fluid circuit 68, pump requirements are determined 104. Included is a determination of the speed or speeds at which the pump 22 will operate, and a determination of the temperatures at which the fluid circuit 68 will operate. For example, in a vehicle application under cold start conditions the fluid and system temperatures will equal ambient conditions and in operation, temperatures increase such as due to friction in the system. From the minimum to the maximum expected operating temperatures, flow requirements (mass flow rates) are evaluated through the range of operation speed(s). Given the flow requirements of the pump and the details of the fluid circuit 68, the pump 22 is selected 106 for the application to provide the needed flow rate(s) under the expected operating conditions. A pump that generates pressures sufficient to overcome the hydraulic resistance of the fluid circuit 68 while achieving the flow requirements is selected. To select the pump 22, reference may be made to available pump performance data or determined from performance testing and/or modelling.

In the current embodiment, a fixed displacement pump 22, such as an internal gear pump is selected. The process 100 continues with a determination 108 of the maximum pump speed. As a fixed displacement pump 22, a fixed amount of fluid is delivered per revolution of the pump 22. In general, flow-rate is increased in proportion to the rotational speed increase of the pump. A high speed fill limit is reached when the pump chambers can no longer be completely filled with fluid due to the high speed at which the rotor 30 is moving, and may be determined by system performance testing and/or modelling, such as using available fluid dynamics software. In determining 108 the maximum pump speed, the high speed fill limit conditions are evaluated throughout the range of operation speeds of the pump 22 and for the range of operating temperatures of the fluid circuit 68. The evaluation may be conducted through performance testing and/or through analysis such as by using available fluid dynamics software. When the maximum pump speed threshold is determined, the system 20 is configured to maintain speeds below the threshold. At the same time, pump speeds are implemented to deliver the fluid flow requirements of the fluid circuit 68. The speed target may be evaluated with reference to pump performance curves available from the manufacturer or developed by characteristic testing and/or modelling. Pump sizing may be re-evaluated is consideration of the limited speed threshold to ensure requirements of the load at achieved.

In coordination with the determination 108 of the maximum pump speed, pump input torque requirements are evaluated 110. Input torque requirements for the pump 22 are evaluated 110 through the range of operating temperatures and flow rates of the fluid circuit 68. The highest torque required may occur under certain conditions. For example, due to fluid viscosity increases with lower temperatures, the maximum torque required to drive the pump 22 may occur at the lowest operating temperatures of the system 20. In other cases, the maximum torque required may be required at the highest flow requirements of the fluid circuit 68, including of the load 28. Accordingly, flow requirements are evaluated over the range of operating temperature and over the range of system flow rates. Iteration may be used to determine where the maximum torque requirement exists within the range of temperature and flow rate variables.

Given the maximum torque requirement, the motor 24 is selected 112 to meet those requirements, with consideration of desirable speeds. Speed-torque characteristics of the motor 24 are aligned with requirements of the pump 22. For example, a BLDC motor 24 that matches the requirements may be selected. With a BLDC motor 24, size (and torque) considerations have an impact on cost due to a number of factors. The use of rare earth materials in the magnets of the motor 24 are minimized by reducing size. Smaller size also leads to less mass and cost of the motor and vehicle wiring. Lower torque and cost may be accomplished by operating at higher speeds, above those at which the pump 22 may be preferably operated. Commercially available finite element method based-based software may be used to assist in motor specification.

The operational speed target of the motor 24 is set 114, based on efficiency and a balance of torque and speed. For example, and with reference to FIG. 3, efficiency is high in the curve segment 98, where speed is above 10,000 revolutions per minute. The speed target is selected at points to the right of the inflection point 97, where torque is below the maximum torque of the motor 24. In embodiments, the speed target may be set 114 at speeds where the torque is less than fifty-percent of the maximum torque. With a motor speed above 10,000 revolutions per minute, and a maximum pump speed in the 5000-6000 revolutions per minute range, a gear configuration is selected 116. Packaging space, speed reduction and torque requirements may be considered in the selection 116. For example, a gearing arrangement, such as spur gears, may be selected 116 for the speed reducer 26 providing approximately a 2:1 speed reduction and a torque multiplication due to input at a smaller gear and output at a larger gear. In other embodiments, such as where a higher reduction ratio is used, a planetary gear arrangement may be used, or another type of gearing arrangement may be selected 116 based on the application's requirements.

Iteration 118 may be used to consider speed and torque requirements in sizing the motor 24 and the gearing in the speed reducer 26. In the evaluation, consideration may be given to the characteristic that operating at high torque may result in the motor 24 heating up and losing efficiency. In addition, mechanical power is the product of torque and speed and so the torque and speed are balanced so that the high speed fill limit threshold of the pump 22 is not exceeded and so that the motor 24 is right sixed to meet torque requirements while operating at efficient speeds. With the motor 24, speed reducer 26 and pump 22 selected, the system 20 is assembled 120 and may be operated to service the load 28. In a number of embodiments, the order of the steps in the process 100 may differ from those described herein, other steps may be added, and some steps may be omitted.

Accordingly, pump systems and methods are provided with an electric motor that spins at efficient speeds, such as greater than 10,000 revolutions per minute. Using speed reduction, the pump spins at speeds below its high speed fill limit, such as below 5000-6000 revolutions per minute. The system has high efficiency, low cost, low electrical current requirements, with more capability (higher pressure and flow).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A method of manufacturing a pump system, the method comprising:
selecting a pump for the pump system;
determining a maximum speed of the pump;
evaluating torque requirements of the pump;
selecting a motor to meet the torque requirements;
setting a speed target for the motor;
selecting and sizing a speed reducer for operation of the motor at the speed target and operation of the pump below the maximum speed; and
coupling the motor with the pump through the speed reducer.

2. The method of claim 1, wherein determining the maximum speed includes determining a high speed fill limit of the pump above which fluid flow of the pump is independent of speed change, and setting the maximum speed at a threshold below the high speed fill limit.

3. The method of claim 2, sizing the speed reducer includes selecting a gear ratio of the speed reducer that results in operating the pump below the high speed fill limit when the motor is operated at the speed target.

4. The method of claim 1, wherein evaluating the torque requirements comprises evaluating the torque requirements for the pump through a range of operating temperatures and flow rates of the pump system.

5. The method of claim 1, wherein setting the speed target includes evaluating, simultaneously, speed and torque requirements of the motor.

6. The method of claim 5, wherein selecting the speed reducer includes selecting the speed reducer that reduces speed from the motor to the pump and that increases torque transferred from the motor to the pump.

7. The method of claim 1, wherein selecting the motor comprises selecting a brushless direct-current motor and selecting the speed reducer includes selecting a planetary gearset for the speed reducer, and comprising coupling the motor to the planetary gearset, and coupling the pump to the planetary gearset.

8. The method of claim 1, comprising fluid coupling the pump with a load, and sizing the pump to meet flow requirements of the load.

9. The method of claim 8, wherein sizing the pump further comprises evaluating flow requirements of the load over a range of operating temperatures.

10. The method of claim 1, comprising determining a maximum torque required to drive the pump over an operating temperature range of the pump.

11. A system of manufacturing a pump system, comprising:
a pump selected and configured to operate at a maximum speed and with evaluated torque requirements;
a motor configured to meet the torque requirements, the motor configured to operate at a set speed target; and
a speed reducer coupled with the motor and the pump, the speed reducer configured to operate the pump below the maximum speed when the motor is operated at the speed target.

12. The system of manufacturing of claim 11, wherein the pump is configured to operate at the maximum speed, which is lower than a high speed fill limit of the pump above which fluid flow of the pump is independent of speed change.

13. The system of manufacturing of claim 12, wherein the speed reducer includes gearing with a ratio that results in operating the pump below the high speed fill limit when the motor is operated at the speed target.

14. The system of manufacturing of claim 11, wherein the motor and the speed reducer are configured to deliver torque requirements for the pump through a range of operating temperatures and flow rates of the pump system.

15. The system of manufacturing of claim 11, wherein the motor is configured to operate at the speed target and simultaneously to meet the torque requirements of the pump over a range of operating temperatures.

16. The system of manufacturing of claim 15, wherein the speed reducer reduces speed from the motor to the pump and that increases torque transferred from the motor to the pump.

17. The system of manufacturing of claim 11, wherein the motor comprises a brushless direct-current motor and the speed reducer comprises a planetary gearset, wherein the motor is coupled to the planetary gearset, and the pump is coupled to the planetary gearset.

18. The system of manufacturing of claim 11, comprising a load serviced by the pump, wherein the pump is fluid coupled with the load, and the pump is configured to meet flow requirements of the load.

19. The system of manufacturing of claim 18, wherein the pump is configured to deliver the flow requirements of the load over a range of operating temperatures.

20. A method of manufacturing a pump system, the method comprising:
selecting a pump for the pump system;
fluid coupling, in a fluid system, the pump with a load that is operated using fluid supplied by the pump
determining, a high speed fill limit of the pump above which fluid flow of the pump is independent of speed change of the pump,
determining a maximum operating speed of the pump at a threshold below the high speed fill limit;
evaluating torque requirements of the pump through a range of operating temperatures and flow rates of the fluid system;
selecting a motor to meet the torque requirements;
setting a speed target for the motor above ten-thousand revolutions per minute;
selecting and sizing a speed reducer for operation of the motor at the speed target and operation of the pump below the maximum speed;
coupling the motor with the pump through the speed reducer; and
coupling the pump with the load to supply the load with fluid from the pump.
